(19) United States
(12) Patent Application Publication
(10) Pub. No.: US 2013/0036620 A1
(43) Pub. Date: Feb. 14, 2013

(54) Rip Cut Measuring Device

(71) Applicant: Terence John Chancellor-Maddison, Escondido, CA (US)

(72) Inventor: Terence John Chancellor-Maddison, Escondido, CA (US)

(21) Appl. No.: 13/209,386

(22) Filed: Aug. 13, 2011

(51) Int. Cl. G01B 1/00

(52) U.S. Cl. 33/527

(57) ABSTRACT

The present invention includes a rip cut measuring device that provides for the accurate measurement of flooring to ensure a proper fit, and is particularly useful when installing flooring in non-square rooms, or rooms with curved walls. The rip cut measuring device of the present invention includes a handle formed with a slide channel marked with offset gauge sized to slidably receive a pencil receiver. The receiver slides along the handle within the slide channel and can be secured in place at a particular offset gauge position corresponding to the width of the flooring being installed. The handle has a slider plate on one end of the handle having wheels to minimize marking and friction on the walls, and on the other end a radius end for use on curved wall surfaces.

### RELATED APPLICATIONS

This application claims the benefit of priority to U.S. Provisional Patent Application Ser. No. 61/290,240 entitled “Rip Cut Measuring Device” by the present inventor, filed Dec. 27, 2009, and currently co-pending.

### FIELD OF THE INVENTION

The present invention relates generally to construction tools. The present invention is more particularly, though not exclusively, useful as a measuring tool to assist with the measuring and marking of flooring products for simplified installations. The present invention is particularly useful as an aid to the proper marking of tile and hardwood floor products to ensure a close fit during installation.

### BACKGROUND OF THE INVENTION

Construction techniques continue to improve as contractor training, the use of technology increases, and the construction material quality improves. Flooring is no exception. Today, a variety of floor types are available. For instance, flooring can consist of ceramic tile, marble, travertine, various types of hardwood, composite wood-product laminates, and carpet and vinyl, just to name a few.

With the increase in the availability of various floor products, also increased is the skill and training necessary to install these products. For instance, many ceramic tile floor substrates must be carefully prepared prior to the installation of tile. Similarly, many types of composite wood-product laminate flooring must be carefully cut, glued, and sealed to insure a long useful life.

In order to install the complex floor products available today, it is often necessary to tightly fit the flooring components together. For instance, in putting a hardwood floor down, it is essential to make careful cuts so that the various pieces are properly aligned and seal closely so as to prevent the accumulation of dust and debris in cracks. Also, it is necessary to carefully measure and cut the ends of the floor product courses so that the flooring is sufficiently close to the walls so baseboard will cover the expansion gap. This is particularly the case when installing composite wood-product flooring that is “floating” on the subfloor as the floor tends to move slightly over time.

Despite the need for a closely cut and properly fitting floor, there are virtually no tools specific to the flooring industry that assist with the proper cutting and measuring of floor products. This is particularly the case when considering the challenges presented by installing a floor in an area that does not have orthogonal walls. Specifically, curved walls, rounded corners, and non-square walls tend to present significant challenges to installers because of the non-standard cuts that are necessary. This challenge often results in waste of flooring product, increased installation times, and unfortunately in cases where the floor does not fit properly, disappointed customers.

In light of the above, it would be advantageous to provide a tool to assist flooring contractors in the proper measuring of flooring products for cutting. It would also be advantageous to provide a tool that is particularly well suited for assisting a flooring contractor in the measurement of complex end-cuts, such as against curved walls or rounded corners. It would also be advantageous to provide a tool that is easy to use, durable for a jobsite, and relatively cost effective.

### SUMMARY OF THE INVENTION

The present invention includes a rip cut measuring device that provides for the accurate measurement of flooring to ensure a proper fit, and is particularly useful when installing flooring in non-square rooms, or rooms with curved walls. The rip cut measuring device of the present invention includes a handle formed with a slide channel marked with offset gauge sized to slidably receive a pencil receiver. The receiver slides along the handle within the slide channel and can be secured in place at a particular offset gauge position corresponding to the width of the flooring being installed.

The handle has a slider plate on one end of the handle having wheels to minimize marking and friction on the walls, and on the other end a radius end for use on curved wall surfaces.

In use, a pencil is positioned in the receiver, and the receiver is set to the measurement corresponding to the thickness of the flooring. For instance, when installing wood plank flooring having a width of 4 inches, the pencil is secured within the slide channel at the offset gauge marking of 4 inches (plus the manufacturer's recommended expansion gap). The workpiece is then positioned over the recently positioned piece of the existing flooring, and the rip cut measuring device of the present invention is positioned against the wall and advanced so that the pencil marks the cut line on the workpiece. Once marked, the workpiece is then cut, and the now cut workpiece is then positioned in place on the floor.

### DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 is a perspective view of the rip cut measuring device of the present invention showing the slider plate and the handle equipped with a dual measurement scale from the plate having rounded ends, and the handle having a radius, and having a pencil receiver for securing and positioning a pencil at a specific measured distance for marking;

FIG. 2 is a top perspective view of the rip cut measuring device of the present invention showing insertion of a pencil (shown in dashed lines) and showing the slide within which the pencil receiver can be adjusted for a particular measurement distance from the slide plate and the handle end radius;

FIG. 3 is a view of the rip cut measuring device of the present invention showing the slider plate equipped with a number of slider wheels to facilitate the slider plate advancing along a wall without marking;

FIG. 4 is a top plan view of the rip cut measuring device of the present invention showing the two measurement scales, the flat surface of the slider plate, and the rounded end of the handle;

FIG. 5 is a cross-sectional view of the rip cut measuring device of the present invention taken along line B-B of FIG. 4, and showing the relative thicknesses of the slider plate and the handle, and the FIG. 6 is a side view of the rip cut measuring device of the present invention showing the relative thicknesses of the handle and slider plate;

FIG. 7 is a cross-sectional view of the rip cut measuring device of the present invention taken along lines A-A of FIG. 4, and showing the relative thicknesses of the handle;

FIG. 8 shows the rip cut measuring device of the present invention having a pencil inserted into the pencil receiver and secured in place for use;

FIG. 9 shows the use of the rip cut measuring device of the present invention with the piece to be cut placed directly over the adjacent row of already-installed flooring and ready to be marked using the rip cut measuring device of the present invention;

FIG. 10 shows the rip cut measuring device of the present invention having a pencil inserted into the pencil receiver and secured within the sliding channel at a distance from the slider plate corresponding to the width of the flooring material being installed, such as 5 inches for a wood plank flooring material having a width of 5 inches, plus a determined expansion gap (such as 0.125 inches), and the slider plate advanced along the wall the length of the flooring material thereby marking the flooring material;

FIG. 11 shows the flooring material that was marked after it has been cut along the marking line created in FIG. 10, and inserted between the last row of flooring material and the wall;

FIG. 12 shows the rip cut measuring device of the present invention being used to mark flooring materials to be installed around a outward curved wall with the material to be cut being placed directly above the adjacent row of already-installed flooring, and the pencil inserted in the pencil receiver positioned within the sliding channel at a distance from the rounded end of the handle corresponding to the width of the flooring material being installed, such as 5 inches or a wood plank flooring material having a width of 5 inches, plus a determined expansion gap (such as 0.125 inches);

FIG. 13 shows the rip cut measuring device of the present invention of FIG. 12 being advanced around the curved wall with the handle perpendicular to the joint between flooring pieces to create a mark on the flooring material to be cut which corresponds to the curvature of the wall;

FIG. 14 shows the positioning of the flooring cut following the marking shown in FIG. 13; and

FIG. 15 is a diagrammatic representation of the rip cut measuring device of the present invention being used on an inward curved wall showing the placement of the device with the pencil receiver set at a distance corresponding to the width of the flooring material, plus a determined expansion gap (such as 0.125 inches), and with the rounded end of the handle advanced around the curved wall, marking the flooring to be cut that has been positioned over the adjacent row of already-installed flooring to mark the piece for cutting and installation.

### DETAILED DESCRIPTION OF A PREFERRED EMBODIMENT

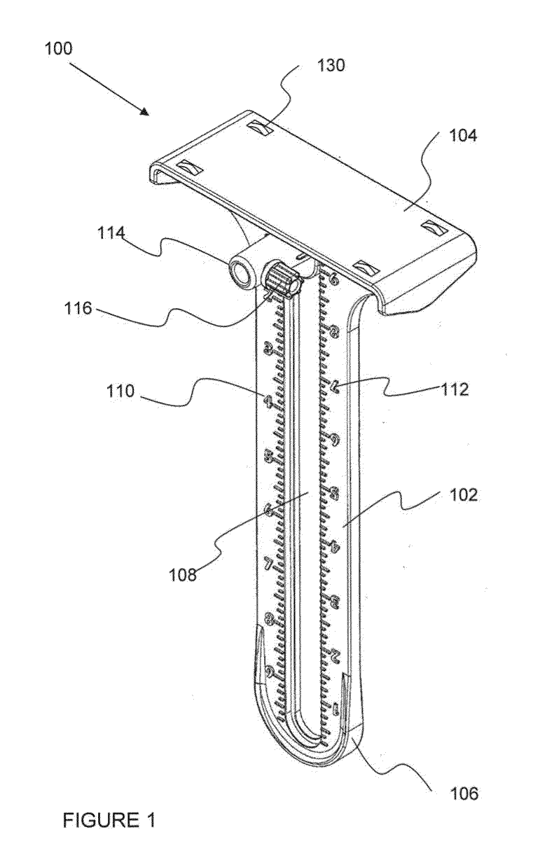

FIG. 1 is a perspective of the rip cut measuring device of the present invention generally designated 100 and showing the slider plate 104 and the handle 102 perpendicular to the slider plate 104 and having a rounded end 106 and having a slide channel 108 equipped with two measuring scales 110 extending away from slider plate 104, and 112 extending away from rounded end 106 to provide relevant distances. A slidable pencil receiver 114 is sized to receive a pencil (134 not shown this Figure) and movable along the slide channel 108 and secured in place a particular cut distance from the slider plate 104 or rounded end 106.

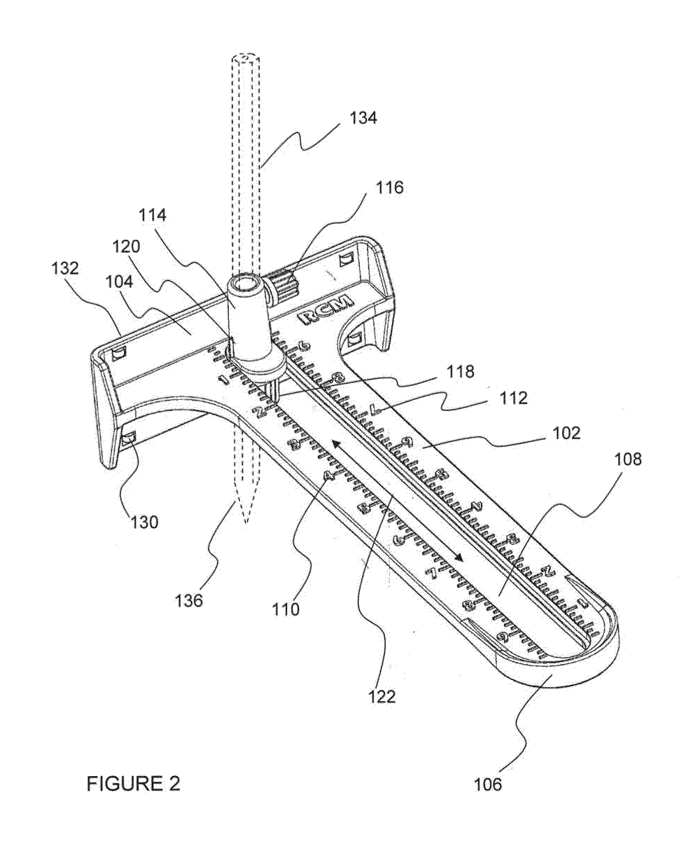

FIG. 2 is a top perspective view of the rip cut measuring device of the present invention 100 showing a pencil 134 (in phantom) secured in place in the pencil receiver 114 and extending downward 136 from the handle 102 to strike a work piece to leave a mark thereon. The pencil receiver 114 may be positioned in direction 122 along the slide channel 108 for adjustment in proper position for marking a workpiece. Pencil 134 is secured in receiver 114 by set screw 116, and pencil receiver 114 is secured in place within the slide channel 108 with nut 118.

Slider plate 104 may be equipped with a number of wheels, or rollers 130 intended to minimize any damage to any wall surface as the device 100 is advanced along the wall for marking purposes.

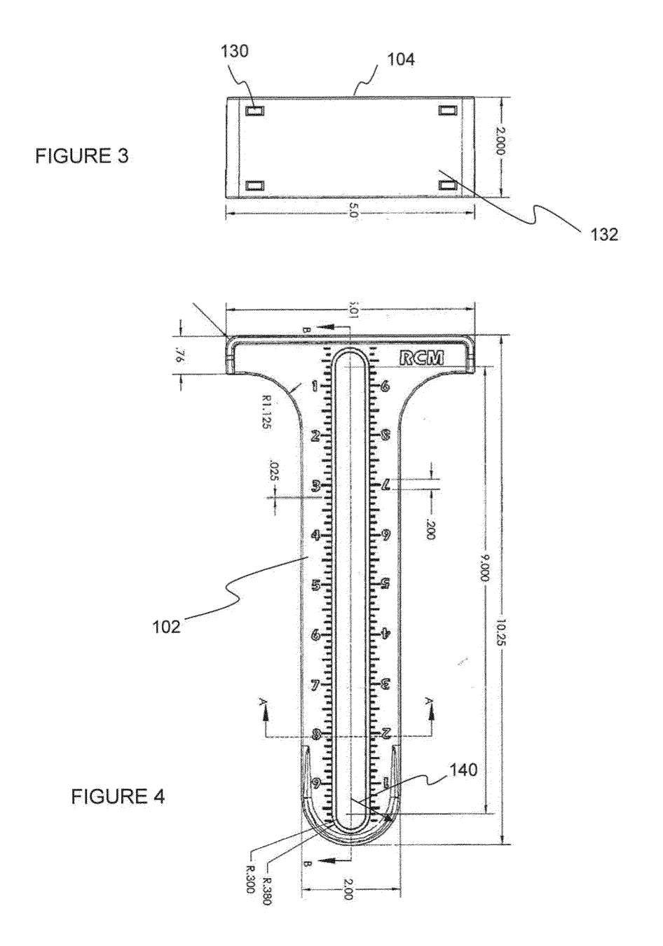

FIG. 3 is a side view of the rip cut measuring device of the present invention showing the placement of rollers positioned on the edges of the slider plate to minimize friction when the device is advanced along a baseboard or wall surface.

FIG. 4 is a top plan view of the rip cut measuring device of the present invention showing the handle formed with the slide channel and equipped with an offset gauge to measure the distance from the slider plate to the pencil set in the slidable receiver.

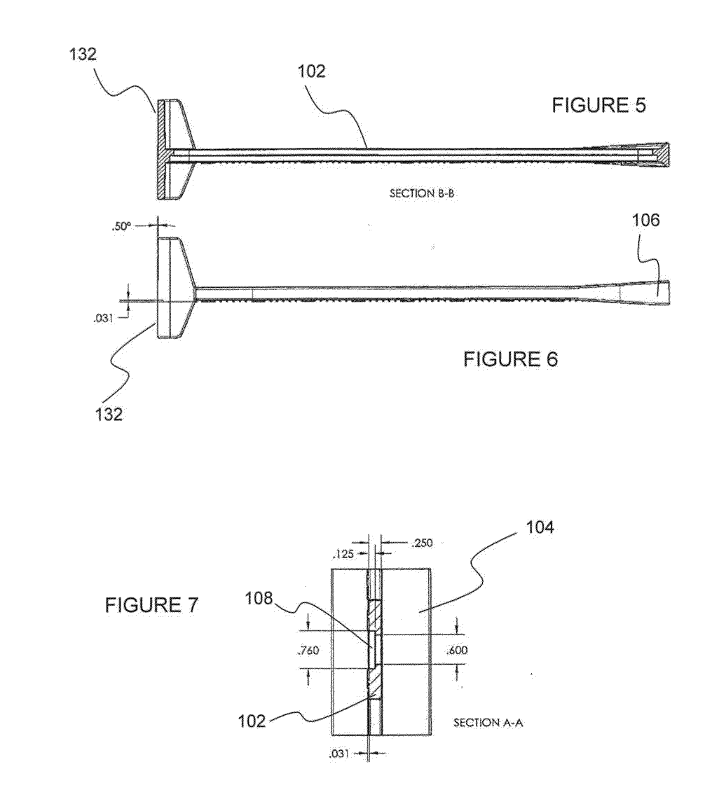

FIG. 5 is a cross-sectional view of the handle and slider plate of the rip cut measuring device of the present invention showing the orthogonal relationship between the slider plate and the handle.

FIG. 6 is a side view of the rip cut measuring device of the present invention.

FIG. 7 is a cross-sectional view of the handle of the rip cut measuring device of the present invention.

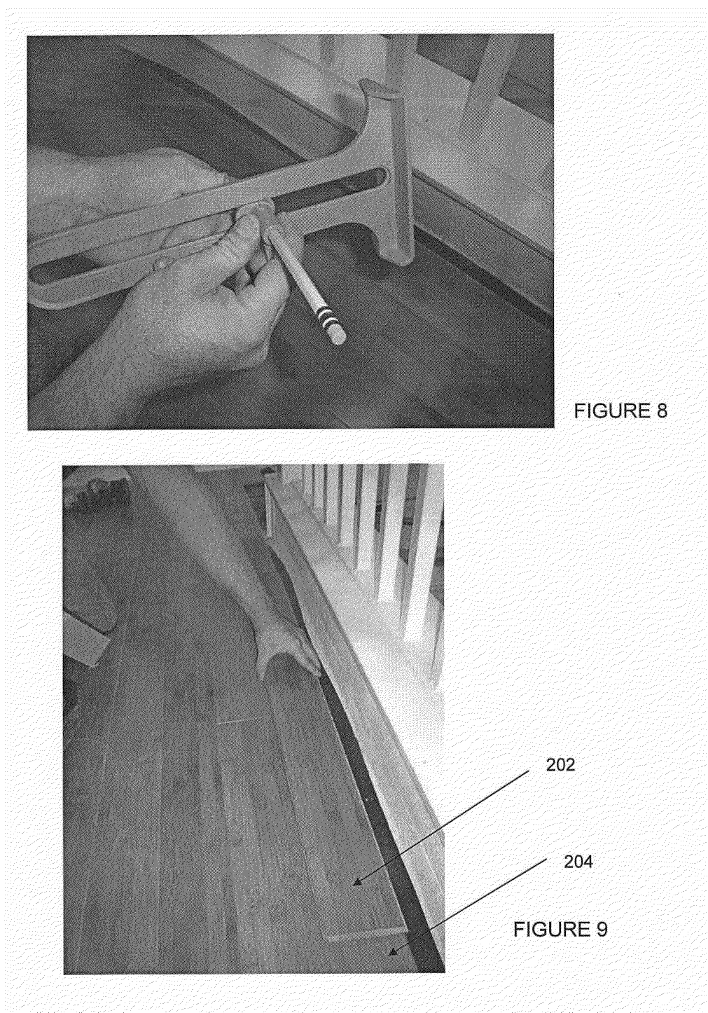

FIG. 8 is a photograph of the rip cut measuring device of the present invention 100 showing the placement of the pencil 134 into the pencil receiver 114 at a specific offset distance from the slider plate.

FIG. 9 is a photograph of the positioning of a workpiece 202 over an existing floor 204 being installed, showing that the new piece is positioned directly over the existing piece in preparation for marking.

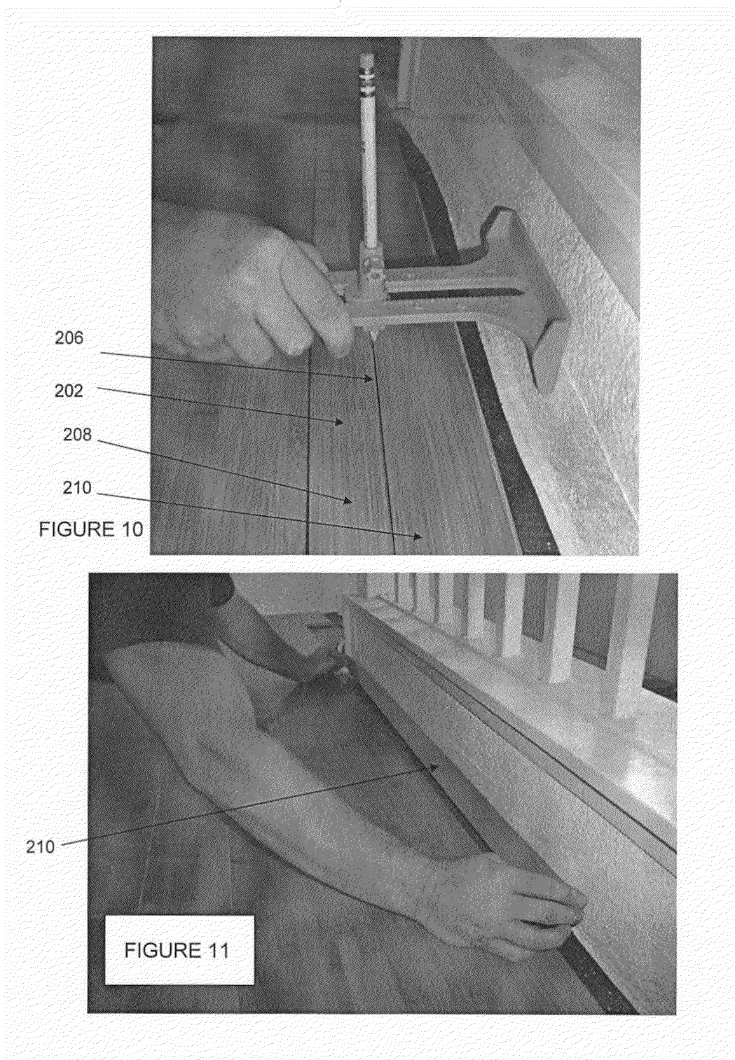

FIG. 10 is a photograph showing the use of the rip cut measuring device 100 of the present invention marking a workpiece 202 by setting the pencil receiver 114 at an offset distance 206 corresponding to the width of the workpiece, placing the workpiece 202 directly over the existing piece on the floor, and sliding the device along the wall as the slider plate 104 is advanced flatly along the wall to maintain the handle at a perpendicular angle to the workpiece. A cut is made along the marked line 206 and portion 210 is discarded; the remaining piece 208 is sized for positioning between the existing floor piece and the wall, leaving sufficient distance for an expansion joint.

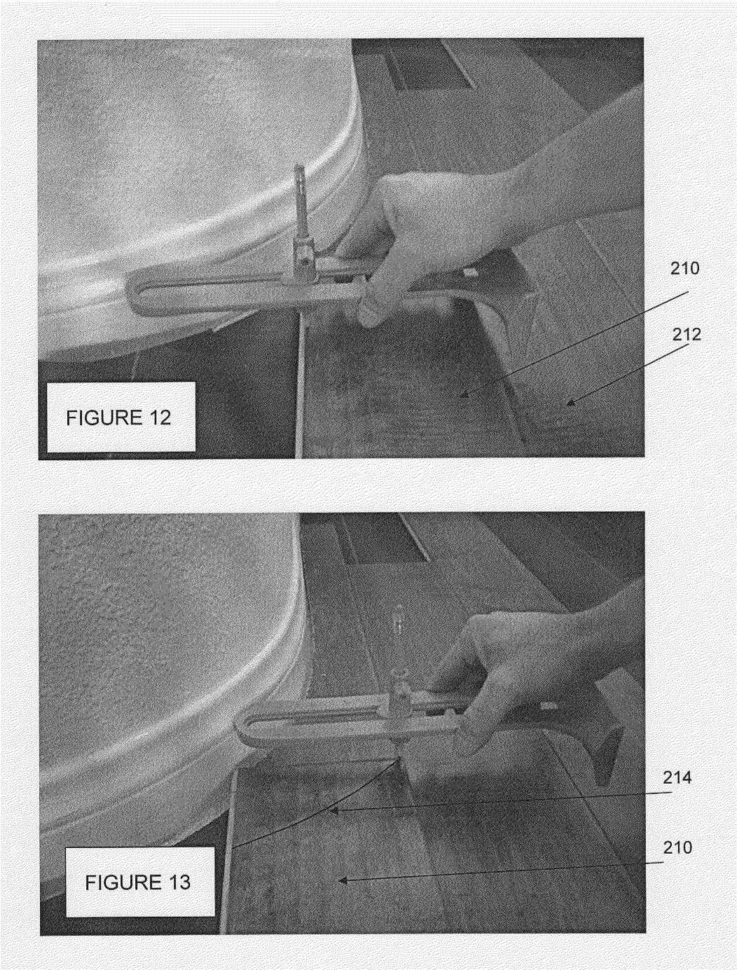

FIG. 11 is a photograph showing the installation of the workpiece 208 after it has been marked with the rip cut measuring device of the present invention and cut for installation.

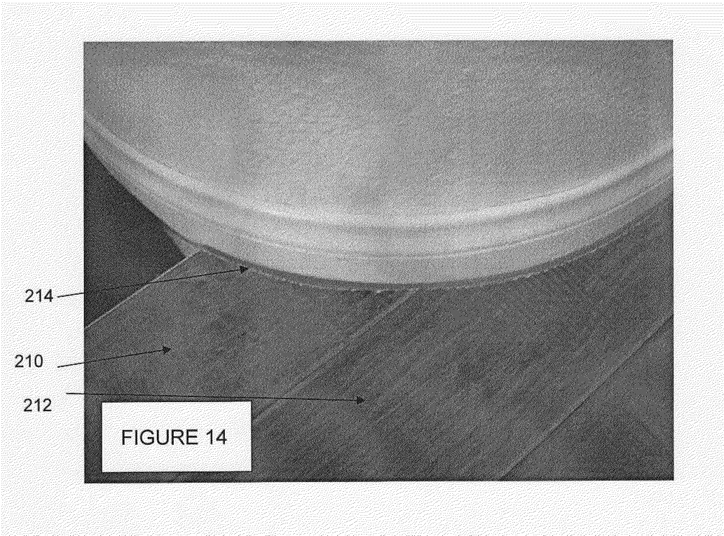

FIG. 12 is a photograph showing the use of the rip cut measuring device 100 of the present invention to mark an outside wall curve by placing the workpiece 210 directly over the existing floor 212, and maintaining the handle perpendicular to the workpiece and sliding the radius end 106 along the surface of the wall to mark the workpiece for cutting.

FIG. 13 is a photograph showing the marking of the workpiece using the rip cut measuring device 100 of the present invention on an outside curvature of the wall, with a marking line 214 being the location of a cut to maintain the curvature of the wall in the workpiece 210.

FIG. 14 is a photograph showing the workpiece 210 after it has been marked and cut 214 with the rip cut measuring device 100 of the present invention, and positioned in place for installation adjacent existing floor 212.

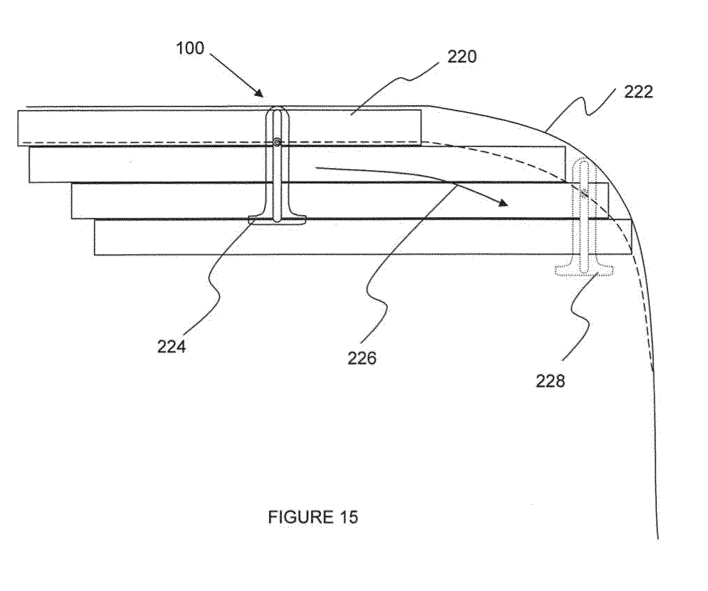

FIG. 15 is a diagrammatic representation of the rip cut measuring device 100 of the present invention being used on an inside wall curvature; showing the workpieces 220 laid out to cover the existing floor, and the marking of the adjacent workpieces by sliding from position 224 to position 228 in direction 226 the radius end 106 of the rip cut measuring device 100 along the wall 222 with the handle perpendicular to the workpiece. Once marked, pieces are then cut and assembled to provide a suitable expansion gap between flooring 220 and wall 222.

While there have been shown what are presently considered to be preferred embodiments of the present invention, it will be apparent to those skilled in the art that various changes and modifications can be made herein without departing from the scope and spirit of the invention.

I claim:

1. A rip cut measuring device, comprising:
a slider plate
a handle extending from and perpendicular to said slider plate and having a rounded end and formed with a slide channel equipped with a measuring scale extending away from said slider plate and toward said rounded end; and
a pencil receiver slidable within said slide channel and sized to receive a pencil.

2. The rip cut measuring device of claim 1, wherein said slider plate further comprises at least two rollers positioned to extend past the surface of said slider plate to contact a wall surface.

3. The rip cut measuring device of claim 1, wherein said handle further comprises a second measuring scale extending away from said rounded end and toward said slider plate.

4. The rip cut measuring device of claim 1, wherein said pencil receiver is formed with a bore sized to receive a pencil, and further comprises a set screw threadable perpendicularly into said bore to secure a pencil therein.

5. The rip cut measuring device of claim 5, wherein said pencil receiver is formed with a threaded bore perpendicular to said pencil-receiving bore, and further comprising a set screw threadable through said threaded bore to secure a pencil within said pencil receiver.

6. The rip cut measuring device of claim 5, wherein said pencil receiver is formed with threaded portion extending through said slide channel and further comprising a nut threadable onto said threaded portion to secure said pencil receiver in position within said slide channel.

7. A method of marking flooring material to be installed, comprising the steps of:
providing a rip cut measuring device comprising: a slider plate; a handle extending from and perpendicular to said slider plate and having a rounded end and formed with a slide channel equipped with a measuring scale extending away from said slider plate and toward said rounded end; and a pencil receiver slidable within said slide channel and sized to receive a pencil;
positioning a to-be-marked flooring material over an already-installed course of flooring material;
determining the width of said flooring material;
positioning said pencil receiver within said slide channel a distance corresponding to the width of said flooring from said slider plate;
positioning a pencil within said pencil receiver;
positioning said slider plate against the wall adjacent the to-be-marked flooring; and
advancing the rip cut measuring device along the wall the length of the to-be-marked flooring wherein the pencil marks the to-be-marked flooring.

8. A method of marking flooring material to be installed, comprising the steps of:
providing a rip cut measuring device comprising: a slider plate; a handle extending from and perpendicular to said slider plate and having a rounded end and formed with a slide channel equipped with a measuring scale extending away from said rounded end and toward said slider plate; and a pencil receiver slidable within said slide channel and sized to receive a pencil;
positioning a to-be-marked flooring material over an already-installed course of flooring material;
determining the width of said flooring material;
positioning said pencil receiver within said slide channel a distance corresponding to the width of said flooring from said rounded end;
positioning a pencil within said pencil receiver;
positioning said rounded end against the wall adjacent and perpendicular to the to-be-marked flooring; and
advancing the rip cut measuring device along the wall the length of the to-be-marked flooring wherein the pencil marks the to-be-marked flooring.
